(19) United States
(12) Patent Application Publication
(10) Pub. No.: US 2025/0194648 A1
(43) Pub. Date: Jun. 19, 2025

(54) METHODS OF PREPARATION OF FOOD COMPOSITIONS USING NUT SHELL MATERIAL OR DRUPE ENDOCARP AND RELATED PRODUCTS

(71) Applicant: RE-NUT AG, St. Gallen (CH)

(72) Inventors: Roland LAUX, Roggwil (CH); Tilo HÜHN, Schönenberg (CH)

(73) Assignee: RE-NUT AG, St. Gallen (CH)

(21) Appl. No.: 18/867,638

(22) PCT Filed: Feb. 10, 2023
(86) PCT No.: PCT/EP2023/053359

§ 371 Date: Nov. 20, 2024

(30) Foreign Application Priority Data
Feb. 11, 2022 (EP) 22156282.0

(51) Int. Cl. A23L 25/00; A23B 2/05; A23B 2/50; A23B 2/57; A23B 2/729

(52) U.S. Cl. CPC A23L 25/30; A23B 2/05; A23B 2/503; A23B 2/57; A23B 2/729

(57) ABSTRACT

Described is a method for preparing a nut paste, comprising the steps of: a) treating the surface of nutshells and/or non-shelled nuts to remove surface contaminants from the shell material; b) preparing a mixture comprising: b1) surface-treated non-shelled nuts, b2) shelled culinary nuts and surface-treated nutshells, and/or b3) shelled culinary nuts and surface-treated non-shelled nuts; and c) grinding the mixture to an average particle size of 500 μm or less to provide a nut paste; wherein the mixture contains at least 0.05 wt.-% of surface-treated nutshell material based on the total weight of solids, and wherein the mixture does not contain added water. The method enables optimized extraction and yield of nutritionally beneficial components of both nut kernels and nut shells while enabling fast and inexpensive processing. In addition, a nut paste obtainable by the aforementioned method and the use of surface-treated nut shells and/or surface-treated non-shelled nuts in ground form as filler material in the preparation of food is described.

### FIELD OF INVENTION

This invention relates to methods and/or techniques for the production of fat-containing food composition (e.g. a nut paste) and related products, wherein nutshell material or drupe endocarp is incorporated to improve the yields of the bioactive materials and which exhibits prolonged storage stability and excellent organoleptic properties.

In certain embodiments, this invention relates to the use of surface-treated nut shells, surface-treated non-shelled nuts and/or drupe endocarp in ground form as filler material in the preparation of food.

### BACKGROUND OF THE INVENTION

In the past decades, the evaluation of the phenolic content and antioxidant activity of different plant-based materials has received increasing interest. Culinary nuts have garnered special attention since their regular consumption is associated with the reduction of risk of diseases such as cancer and cardiovascular diseases.

In conventional processing of nuts for food consumption, shell and skin materials of culinary nuts are often considered as undesired by-products and are discarded, which not only represents an economic problem for the producers but may also lead to a serious impact on the environment due to the combustion of residues. Similarly, in the preparation of drupe seed-based products (e.g. persipan compositions comprising apricot kernels or peach kernels, kernel oil extracts or the like), the hardened endocarp of surrounding the seed is typically disposed as solid waste or burned for energy recovery at processing plants.

However, recent studies indicate that shell materials of numerous culinary nuts likewise contain valuable dietary fibers and especially high amounts of antioxidants, such as polyphenols and flavonoids, which play an important role in the absorption or neutralization of free radicals. For instance, high antioxidant activity has been reported for shell materials of peanuts (B. Adhikari et al., Journal of the Saudi Society of Agricultural Sciences 2019, 18, 437-442), Pecan nuts (A. C. Pinheiro do Prado et al., Grasas Y Aceites 2009, 60(4), 330-335) and hazelnuts (T. Esposito et al., International Journal of Molecular Sciences 2017, 18, 392). In addition, walnut shell has been identified as a valuable source many natural compounds such as phenols and flavonoids which have potential inhibitory effect on pancreatic lipase (V. Akbari et al., Food Chemistry, 2012, 135:2404-2410).

Hence, it would be desirable to provide methods of preparation of edible food compositions (e.g. nut-based products, such as nut-based spreads or butter-like products), which make ideal use of the valuable ingredients of nut shells and drupe endocarp.

Conventional methods of preparing nut-based paste or butter-like spreads often have the disadvantage that it is difficult to simultaneously achieve favorable organoleptic properties and texture, tasty appearance and high yields of nutritionally favorable components without a large number of processing steps, elaborate equipment and high production costs.

For instance, U.S. Pat. No. 5,508,057 A discloses a method for the preparation of a nut paste with improved fluidity and texture, which, however, requires the use of a homogenizer which is operated at a high pressure while controlling the viscosity at less than 15 poise and maintaining the fat content of the paste at least about 45%.

It is known that some of the aforementioned difficulties may be mitigated by modifying the nut-based compositions before they are being subjected to mechanical processing. For example, US 2004/0081744 A1 discloses a method for producing a nut paste with smooth texture, wherein edible oils and liquid sweetening agents (e.g. honey and molasses) are added before grinding and comminution to facilitate the mechanical processing and to provide a nut butter spread with improved texture. However, addition of edible oils tends to promote rancidity and may lead to further reduced shelf stability due to the separation of solid and oil phases. Moreover, such additives are incompatible with the provision of low calorie and/or low fat nut paste products. Manufacturing of the latter typically requires additional pre-processing steps including defatting/deoiling of the nut kernels in combination with addition of water (see U.S. Pat. No. 5,876,781 A, for example), which renders the nut paste susceptible to mold, fungus and bacterial growth, however. EP 3 903 601 A1 relates to a method of processing culinary nuts, including shell material, but also teaches wet grinding methods in water and subsequent phase separation as an essential features of the invention.

US 2020/297013 A1 discloses a nut paste preparation method, which comprises processing blanched, unroasted nuts with a shear mixer in absence of water or oil. EP 2 476 317 A1 discloses the preparation of almond drinks comprising dry grinding. US 2020/0236982 A1 discloses the removal of nut shells prior to the milling step as an essential feature of the invention. US 2005/084549 A is exclusively concerned with the provision of fibre-rich extracts from fenugreek seeds for pharmaceutical uses. Therefore, none of these publications disclose or suggest processing nut shell material for food preparations.

Therefore, it remains desirable to provide a method which is capable of effectively processing culinary nuts or other fat-containing food while simultaneously providing high yields of the bioactive materials present in nut shells or drupe endocarp and enabling simple and inexpensive production of edible fat-containing products (e.g. culinary nut paste) with prolonged storage stability and low fat and/or low caloric properties.

### SUMMARY OF THE INVENTION

The present invention solves this object with the subject matter of the claims as defined herein. The advantages of the present invention will be further explained in detail in the section below and further advantages will become apparent to the skilled artisan upon consideration of the invention disclosure.

Generally speaking, in one aspect the present invention provides a method for preparing an edible fat-containing food product, comprising the steps of: a) treating the surface of nutshells and/or non-shelled nuts to remove surface contaminants, or optionally separating drupe endocarp from drupe seed kernels; b) preparing a mixture comprising at least one of: b1) surface-treated non-shelled nuts, b2) fat-containing food and surface-treated nutshells, b3) fat-containing food and surface-treated non-shelled nuts or b4) fat-containing food and drupe endocarp; and c) grinding the mixture to an average particle size of 500 μm or less to provide an edible fat-containing food product; wherein the mixture contains at least 0.05 wt.-% of surface-treated nutshell material or at least 0.05 wt.-% of drupe endocarp based on the total weight of solids, and wherein the mixture does not contain added water.

In another aspect, the present invention provides a method for preparing an edible fat-containing food product, comprising the steps of: a) treating the surface of nutshells and/or non-shelled nuts to remove surface contaminants; b) preparing a mixture comprising at least one of: b1) surface-treated non-shelled nuts, b2) fat-containing food and surface-treated nutshells or b3) fat-containing food and surface-treated non-shelled nuts; and c) grinding the mixture to an average particle size of 500 μm or less to provide an edible fat-containing food product; wherein the mixture contains at least 0.05 wt.-% of surface-treated nutshell material, and wherein the mixture does not contain added water.

In a further aspect, the present invention provides a method for preparing a nut paste, comprising the steps of: a) treating the surface of nutshells and/or non-shelled nuts to remove surface contaminants from the shell material; b) preparing a mixture comprising at least one of: b1) surface-treated non-shelled nuts, b2) shelled culinary nuts and surface-treated nutshells, or b3) shelled culinary nuts and surface-treated non-shelled nuts; and c) grinding the mixture to an average particle size of 500 μm or less to provide a nut paste; wherein the mixture contains at least 0.05 wt.-% of surface-treated nutshell material based on the total weight of solids, and wherein the mixture does not contain added water.

In another aspect, the present invention provides a method for preparing an edible fat-containing food product, comprising the steps of: a) optionally separating drupe endocarp from drupe seed kernels; b) preparing a mixture comprising: b4) fat-containing food and drupe endocarp; and c) grinding the mixture to an average particle size of 500 μm or less to provide an edible fat-containing food product; wherein the mixture contains at least 0.05 wt.-% of drupe endocarp based on the total weight of solids, and wherein the mixture does not contain added water.

Advantageously, said methods allow optimized extraction and yield of nutritionally beneficial components of drupe endocarp, nut kernels and nut shells while enabling fast and inexpensive processing and making effective use of materials which would be otherwise discarded. In addition, elaborate separation of shell and husk material in advance may at least partly be omitted, which further simplifies the process and improves the yield of nutritionally useful components present in the shell.

In further aspects, the present invention relates to an edible fat-containing product (e.g. a nut paste) obtainable by the aforementioned method.

In other aspects, the present invention relates to the use of drupe endocarp, surface-treated nut shells and/or surface-treated non-shelled nuts in ground form as filler material in the preparation of food, wherein the drupe endocarp, surface-treated nut shells and/or surface-treated have been ground without addition of water.

### BRIEF DESCRIPTION OF THE DRAWINGS

FIG. 1 is a flow chart illustrating an exemplary method of culinary nut processing to provide a nut paste in accordance to the present invention.

### DETAILED DESCRIPTION OF THE INVENTION

For a more complete understanding of the present invention, reference is now made to the following description of the illustrative embodiments thereof:

### Method for the Preparation of an Edible Fat-Containing Product

In a first embodiment, the present invention generally relates to a method for preparing an edible fat-containing food product, comprising the steps of: a) treating the surface of nutshells and/or non-shelled nuts to remove surface contaminants, or optionally separating drupe endocarp from drupe seed kernels; b) preparing a mixture comprising at least one of: b1) surface-treated non-shelled nuts, b2) fat-containing food and surface-treated nutshells, b3) fat-containing food and surface-treated non-shelled nuts or b4) fat-containing food and drupe endocarp; and c) grinding the mixture to an average particle size of 500 μm or less to provide an edible fat-containing food product; wherein the mixture contains at least 0.05 wt.-% of surface-treated nutshell material or at least 0.05 wt.-% of drupe endocarp based on the total weight of solids, and wherein the mixture does not contain added water.

The term “fat-containing food”, as used herein, generally encompasses edible processed or non-processed food of animal and/or plant origin, which is fit for human or animal consumption and which comprises one or more fats in solid or liquid form at room temperature. Examples thereof include, but are not limited to baked goods, cereals, dairy products (e.g. butter), edible plants (e.g. edible nuts, seeds, legumes, vegetables, fruits or herbs), edible fungi, meat, egg, seafood and combinations thereof. Preferred embodiments include dairy products (e.g. butter), edible plants and extracts thereof, while edible plants and extracts thereof are particularly preferred and edible nuts, seeds, legumes, vegetables, fruits and extracts thereof are especially preferred. As will be outlined below, it may be preferable from the viewpoint of simplified processing that the fat-containing food has a total fat content of at least 25 wt.-% based on the total weight of solids, more preferably from 35 to 95 wt.-% and further preferably from 40 to 80 wt.-%, which enables easier adjustment to the desired fat contents. It will be understood that such fat contents may be present in the original (non-processed) food source or be suitably adjusted beforehand by addition of edible fats and/or oils or by defatting procedures. In general, the fatty acid composition in terms of the content or ratio of saturated and non-saturated fats is not particularly limited.

In one preferred embodiment of the above-described first embodiment, the present invention relates to a method for preparing an edible fat-containing food product, comprising the steps of: a) optionally separating drupe endocarp from drupe seed kernels; b) preparing a mixture comprising: b4) fat-containing food and drupe endocarp; and c) grinding the mixture to an average particle size of 500 μm or less to provide an edible fat-containing food product; wherein the mixture contains at least 0.05 wt.-% of drupe endocarp based on the total weight of solids, and wherein the mixture does not contain added water.

Drupes, also known as stone fruits, are a group of plants, the majority of which belong to the genus Prunus L., provide a nutrient-rich source for the human body. Exemplary drupes for the purpose of the present invention include apricots, olives, dates, pistachios, cherries, blackberries, peaches, coconuts and mangoes, for example. The name “stone fruit” is derived from the lignified, woody endocarp (stone or pit) encompassing a kernel (epicarp). The fleshy epicarp and mesocarp, which envelop the stony endocarp, are generally considered as the edible parts of drupes. For instance, it is known to process stone fruit kernels to extract oils or to produce edible pastes, such as in the preparation of persipan based on detoxified apricot kernels. However, in any of these processes, the stones are first crushed drupe endocarp is separated from the epicarp and mesocarp and typically discarded and/or burned upon harvesting. The present invention enables the effective use of the lignified drupe endocarp by exploiting its excellent abrasive properties in the grinding stage of step c), while simultaneously introducing the same into edible fat-containing products as a filler with nutritionally valuable properties. In principle, the entire stone (pit) including the kernel (epicarp) may be used in the preparation of the mixture in step b). However, depending on the cultivar, the kernel may contain undesirably high contents of amygdalin (D-mandelonitrile-2-D-gentiobioside), which is a cyanogenic glycoside, the enzymatic degradation of which can lead to the production of cyanide when kernels are macerated or crushed. For this purpose it may be preferable to separate the drupe endocarp from drupe seed kernels in step a) by crushing and sieving, for example. In a preferred embodiment, the separated drupe seed kernels may be detoxified by methods known in the art (e.g., by decontamination with solvents (e.g., water, brine or ethanol), by enzymatic treatment (e.g., with β-glycosidase), microbial fermentation or ultrasonication) and reintroduced into the mixture in step b), which advantageously makes use of the nutritionally valuable components of the kernels (e.g. unsaturated fatty acids, phenolic compounds, Vitamin E, tocopherols, and β-carotene) and further helps fine-tuning the fat content for simplified grinding in step c).

In an alternatively preferred embodiment of the above-described first embodiment, the edible fat-containing food product is a nut paste. In this case, a method for preparing a nut pasteaccording to the present invention comprises the steps of: a) treating the surface of nutshells and/or non-shelled nuts to remove surface contaminants from the shell material; b) preparing a mixture comprising at least one of: b1) surface-treated non-shelled nuts, b2) shelled culinary nuts and surface-treated nutshells, or b3) shelled culinary nuts and surface-treated non-shelled nuts; and c) grinding the mixture to an average particle size of 500 μm or less to provide a nut paste; wherein the mixture contains at least 0.05 wt.-% of surface-treated nutshell material based on the total weight of solids, and wherein the mixture does not contain added water.

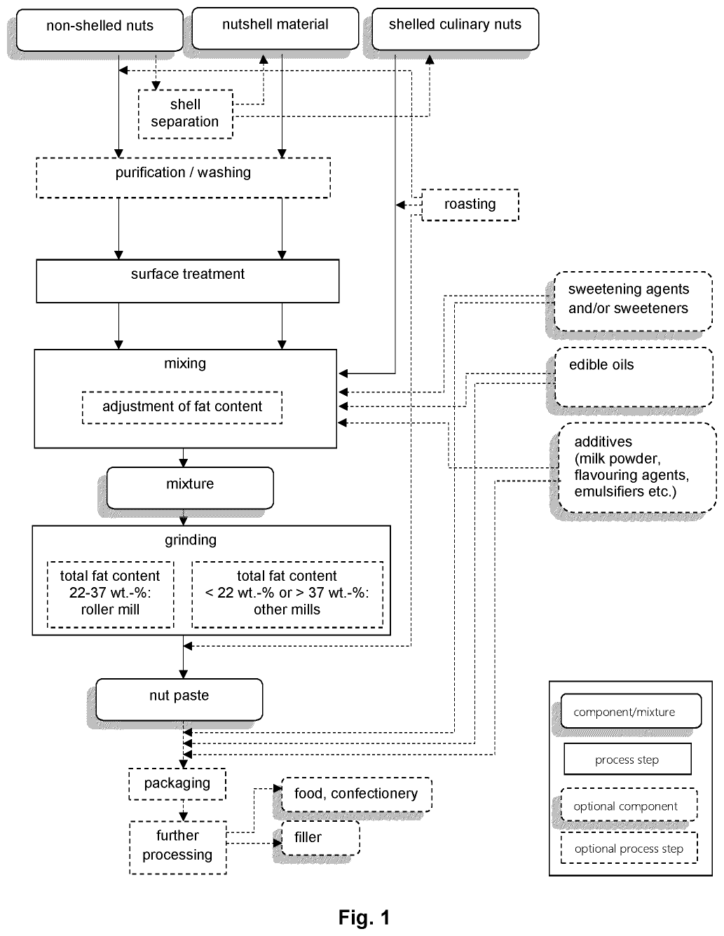

An exemplary embodiment of the aaforementioned method is illustrated in FIG. 1.

The method for preparing a nut paste according to the present invention generally begins with a step a) of treating the surface of nutshells and/or non-shelled nuts to remove surface contaminants (such as soil- and dust-borne contaminants, pollutants, bacterial contaminants and/or mycotoxins, for example) from the shell. For this purpose, the surface of nutshells and/or non-shelled nuts may be subjected to chemical sterilization (for instance, with microbiocidal substances such as alcohols (e.g. ethanol), aldehydes, oxidizing agents, phenolics or quaternary ammonium compounds), washing in sterile water, enzymatic treatment, surface sterilization or pasteurization by means of heat and/or irradiation with ionizing rays, ultrasound-based sterilization and combinations thereof, for example.

Alternatively, or in addition, step a) may preferably include a step of stripping off the outermost layer of the surface of the nutshells and/or non-shelled nuts. A suitable technique includes abrasive blasting of the surface. In a particularly preferred embodiment, abrasive blasting is performed with bio-based abrasive media, such as fruit stone powders (e.g., powdered stones of olives, peaches, mangoes, plums, cherries, apricots or avocados) or nutshell-based abrasives, which offer a softer, gentler media blasting alternative in dry air blasting applications when compared to harsher materials such as metal oxide, glass bead or steel shot or steel grit media, and enable gentle abrasion of the surface while avoiding contact between the treated shell and foreign, non-edible matter. Accordingly, the potentially contaminated surface of the nutshell may be selectively removed while leaving the valuable nutshell constituents intact.

Preferred examples of nutshell-based abrasives include, but are not limited to abrasive media comprising walnut shells, pistachio shells or almond shells, for example. Walnut shell abrasives are particularly preferred in view of their chemically inertness, hardness, biodegradability, nontoxicity and wide availability.

In a further preferred embodiment, undesired micropollutants and odours, may be removed from surface of the nutshells and/or non-shelled nuts by adsorbing agents, such as activated carbon, for example.

In embodiments, non-shelled nuts may be subjected to step a) in a green state to make use of the favorably high antioxidant content when compared to the ripened nut. In this context, “green state” denotes a state before ripeness, which may be determined by the skilled artisan by methods known in the art (based on appearance, consistency, and/or water content, for example) in dependence of the individual nut type.

Step b) generally includes the preparation of a mixture comprising at least one of: b1) surface-treated non-shelled nuts, b2) shelled culinary nuts and surface-treated nutshells, b3) shelled culinary nuts and surface-treated non-shelled nuts and/or b4) fat-containing food and drupe endocarp.

Since the nutshell material introduced into the mixture in step b) is retained in the final edible fat-containing product, it must be ensured that the nutshell does not contain effective amounts of allergens or toxic substances in the inner layer of the shell, which may be either accomplished by pre-treating the nutshells to remove harmful substances (e.g. by extraction) prior to the addition to the mixture in step b) or by suitably selecting the nut type providing the nutshell according to its non-toxicity and low contents of allergens. Under these aspects, almonds, pecans, walnuts, cashews, pistachios, peanuts, kola nuts, palm nuts, hazelnuts, filberts, Brazil nuts, macadamia nuts, chestnuts, and mixtures thereof are preferably employed as non-shelled nuts or to provide the shell material. In further preferred embodiments, the nutshells are selected from hazelnut shells, peanut shells, walnut shells, almond shells, pistachio shells, and combinations thereof; and/or the non-shelled nuts are selected from non-shelled hazelnuts, non-shelled peanuts, non-shelled walnuts, non-shelled almonds, non-shelled pistachios, and combinations thereof.

On the other hand, for material only introduced as nut kernels in step b) (referred to herein as “shelled culinary nuts” in b2) and b3)), a wider choice of culinary nuts may be employed. The term “culinary nut”, as used herein, includes any tree nut, seed or legume, including any species of any genus of nuts, legumes, or seeds, and any mixtures thereof, while nuts, drupe seeds, nut-like gymnosperm seeds and nut-like angiosperm seeds are preferred. A single varietal or species may be used, or any conceivable mixtures of nuts, or mixtures of nuts and legumes, or combinations of tree nuts, seeds and legumes. As examples of nuts, almonds, pecans, walnuts, cashews, pistachios, peanuts, kola nuts, palm nuts, hazelnuts, filberts, Brazil nuts, macadamia nuts, chestnuts, and mixtures thereof may be mentioned, while suitable seeds may include oat, sesame seeds, pine nuts, sunflower seeds, pumpkin seeds, beans and/or rice for example. It is also within the scope of the present disclosure to use legumes (including, but not limited to soybeans, peanuts, navy beans, kidney beans, lima beans, string beans, pinto beans, chickpeas (garbanzo beans), lentils, peas, black-eyed peas, for example) particularly those falling into the definition of culinary nuts in ordinary parlance, such as peanuts, for example. In particularly preferred embodiments, the term “culinary nut” comprises hazelnuts, almonds, walnuts, cashews, pistachios, pecans, macadamia nuts, peanuts, and combinations thereof.

Before being subjected to step b), the culinary nuts may be pre-processed by sterilization, blanching, shocking, washing and combinations thereof.

In terms of the starting material, the nutshell and kernels may originate from the same type of nut or from different nut species and/or cultivars. In addition, as is indicated in FIG. 1, nutshells may optionally be separated from the kernels and the shelled nuts may be processed separately before being recombined in step b).

In step b), a mixture is prepared, comprising at least one of b1) surface-treated non-shelled nuts, b2) shelled culinary nuts and surface-treated nutshells, b3) shelled culinary nuts and surface-treated non-shelled nuts and b4) fat-containing food and drupe endocarp. The processing of nutshells together with culinary nut kernels eliminates the need for specialized equipment and processing steps required for the shell separation.

In preferred embodiments, the mixture comprises surface-treated non-shelled nuts or shelled culinary nuts and surface-treated nutshells in a (total) content of at least 1% by weight based on the total weight of solids, more preferably in a total content of from 5 to 100% by weight, and further preferably in a total content of from 10 to 100% by weight, such as from 40 to 100%, or from 60 to 100% by weight. In case of admixing drupe endocarp, the mixture preferably comprises drupe endocarp in a content of at least 1% by weight based on the total weight of solids, more preferably in a total content of from 2 to 50% by weight, and further preferably in a total content of from 4 to 40% by weight.

From the perspective of sustainability, by-products of food processing, agriculture, and forestry that are typically discarded and/or burned may be added to the mixture before or during step c) as filler material, grinding abrasives and/or to make use of valuable nutrients. Examples of such by-products include, but are not limited to tree bark (especially inner bark (phloeam and vascular cambium) of pine trees or deciduous trees, such as ash, aspen, birch, or elm, for example), non-woody pericarp or exocarp of culinary nuts or stone fruits (e.g. almond exocarp, hazelnut or macadamia pericarp), or the like.

Optionally, further additives may be added to the mixture depending on the recipe and the desired textural and organoleptic properties. While not being limited thereto, exemplary additives may include sugars or other sweeteners (including maple syrup, honey, molasses, sucrose, fructose, glucose syrup, invert sugar, fruit sugar, corn syrup, sucralose, acesulfame potassium, aspartame, saccharin, cyclamates, acesulfame-K, thaumatin, chalcone, cyclamate, stevioside, stevia, sorbitol, xylitol and lactitol etc.), salt or salt substitutes, flavoring agents (e.g. cocoa powder, cocoa liquor, cocoa beans, coffee beans, vanillin or the like), milk powder, edible oils (essential oils or vegetable oils, such as palm oil, canola oil, peanut oil, walnut oil, rapeseed oil, cottonseed oil, soybean oil or coconut oil, for example), vitamins, minerals, proteins (e.g., whey protein, soy protein, albumin, sunflower seeds etc.), fruit pieces, herbs and/or spices (including without limitation cinnamon, ginger, coriander, cumin, turmeric, chili, pepper, cardamom, cloves, nutmeg, etc.), preservatives, colorants, thickeners, stabilizers (e.g. saturated triglycerides, monoglycerides, diglycerides and combinations thereof), emulsifiers (e.g., lecithin) and combinations thereof, for example.

In one exemplary embodiment, the mixture prepared in step b) comprises: surface-treated non-shelled nuts or shelled culinary nuts and surface-treated nutshells in a (total) content of from 5 to 99% by weight, preferably from 10 to 98% by weight; sweetening agents, sweeteners, or combinations thereof, in a total content of from 0.5 to 60% by weight, preferably from 1 to 40% by weight; one or more edible oils in a total content of from 0.1 to 55% by weight, preferably from 0.5 to 45% by weight; and one or more additives selected from milk powder, flavoring agents, emulsifiers and combinations thereof, in a total content of from 0.1 to 50% by weight, preferably from 0.5 to 40% by weight.

In general, the mixture prepared in step b) independently contains at least 0.05 wt.-% of surface-treated nutshell material or drupe endocarp based on the total weight of solids, which is well above trace amounts typically measured in conventional nut paste preparation or food compositions involving drupe processing. In order to make ideal use of the biologically active components of the nutshell or drupe endocarp, the mixture preferably contains at least 0.5 wt.-% of surface-treated nutshell material or drupe endocarp based on the total weight of solids, more preferably at least 1 wt.-% and further preferably at least 5 wt.-%. The upper limit is not particularly limited and may be suitably selected depending on the type of nutshell or drupe endocarp or the desired fat content of the edible fat-containing product, as will be further explained below.

According to the present invention, the mixture subjected to grinding in step c) does not contain added water or added aqueous liquids (including milk or the like), which means that step c) is performed as a dry-grinding step or that only lipophilic liquids (e.g. edible oils) previously added to the mixture are present during grinding. If water or aqueous solutions are used for washing in step a), they should be suitably removed before step c), e.g. by evaporation.

In step c), the mixture is ground to an average particle size of 500 μm or less to provide the edible fat-containing product. Average particle sizes of 200 μm or less, 100 μm or less, 50 μm or less, 30 μm or less or 20 μm or less are further preferred in view of the texture and mouthfeel of the resulting edible fat-containing product. The grinding of the mixture may be carried out in one or in multiple steps. In general, the average particle size may be measured as volume moment mean (D[4,3]), and is typically defined by all particle sizes contributing according to their volume fraction in the collective, so that the average particle size in the interval is weighted with the corresponding volume portion and all these weighted values are averaged arithmetically. The particle sizes and their distribution may be suitably determined by methods known in the art (e.g. by a particle size analyzer).

In the preparation of the mixture in step b), it has been found that the total fat content of the mixture plays an important role in the processability in the grinding step c) and the organoleptic properties of the product.

Typically, kernels of culinary nuts exhibit a total fat content in the range of from about 40 to about 75 wt.-%.

In a particularly preferred embodiment of the method of the invention, surface-treated nutshells, surface-treated non-shelled nuts and/or drupe endocarp materials are added in step b) until the mixture has a total fat content of from 22 to 37 wt.-%. Accordingly, by adding nutshell material and/or drupe endocarp as a filler, relatively low fat contents may be achieved without the necessity of a defatting or deoiling step, which typically involves a chemical treatment or a mechanical removal of oils and fats (e.g., with a hydraulic press, an expeller or a centrifuge), both of which tend to lead to a loss of sensitive antioxidants. Moreover, since the fat content is relatively low and the mixture does not contain added water, the rancidity of the edible fat-containing product is reduced and storage stability may be further improved. Last but not least, by adjusting the total fat content to the above range, the mixture may be smoothly ground in step c) by using a conventional roll mill, which substantially reduces the processing costs compared to the use of alternative grinding equipment. Specifically, it has been found that if the fat content of the mixture is less than 22 wt.-%, the mixture is non-flowable and causes blocking in roll mills, whereas fat contents of higher 37 wt.-% cause undesirable smearing in the roll grinding process, which is detrimental to the grinding effect and the resulting textural properties of the edible fat-containing product. In this embodiment, if the grinding in step c) consists of multiple grinding steps, at least the initial (coarse) grinding step is performed with a roller mill, whereas one or more fine grinding steps may also be performed with different mills or grinders. However, it is preferred that the entire grinding step c) down to the finest average particle size is performed with a single roll mill, or with multiple roll mills with descending roller nip sizes (i.e. space between the rollers).

In an alternative embodiment, the mixture prepared in step b) has a total fat content of less than 22 wt.-% or more than 37 wt.-%, such as from more than 37 wt.-% to 70 wt.-%, for example, which may be typically the case if small amounts of nutshell material or drupe endocarp are present and/or if edible oils are added to the mixture to promote the smoothness of the paste. In this case, step c) is preferably performed with a pin mill, a hammer mill, a screen mill, a colloid mill or combinations thereof, in order to provide an edible fat-containing product with favorable texture.

Notably, the total fat content, as referred to herein, may be determined according to methods known to the skilled artisan, including gas chromatography (GC) or solvent extraction-gravimetric methods, among which GC methods are preferred.

As indicated above, it is preferred that the method of the present invention does not comprise a defatting or deoiling step at all. Instead, it is preferred to primarily control the fat content by adjusting the mixture in step b).

A heat treatment may be incorporated at several stages of the processing method to introduce roast flavors. For example, shelled culinary nuts may be roasted before the mixing step b) and/or non-shelled nuts may be roasted in the shell after the surface treatment and before step b) to promote processability in the grinding stage (see FIG. 1).

In some embodiments, it may be also preferable to subject the ground mass obtained in step c) to roasting, especially when additives such as flavorants, salts, sugars or other sweeteners have been added to the mixture, whereupon development of complex flavors during Maillard reactions occurring during roasting is further promoted. In a preferred embodiment, salt (e.g., sodium chloride) may be added before the roasting step in order to enhance the solubility of proteinogenic substances as precursors for the Maillard reactions. Advantageously, it has been found that roasting the ground mass including nutshell and/or drupe endocarp material results in an enhanced perception of sweet constituents in the final edible product, so that less sugar and/or sweetener is required in comparison to conventional products.

While not being limited thereto, typical roasting temperatures will be generally in the range of more than 65° C. and 200° C. or less, preferably between 70 and 160° C., such as from 80 to 150° C.

The method of carrying out the roasting is not particularly limited and may e.g. be accomplished in a drum dryer. In a preferred embodiment, the roasting step is carried out in a mixing device comprising a cylindrical, tubular body arranged with its axis horizontal and closed at its opposite ends by end plates, and having a coaxial heating or cooling jacket through which, for example, diathermic oil or another fluid is intended to flow to keep the internal wall of the body at a predetermined temperature. The tubular body has an inlet and outlet openings for the solid phase. The outlet opening communicates, by means of a duct, with a device for separating the aroma phase from the dried product. The device further comprises a bladed rotor is supported for rotation in the tubular body, its blades being arranged as a helix and oriented for centrifuging the solid phase being processed and simultaneously transporting it towards the outlet opening. The roasting step may be followed by a cooling step, which may be carried out by air cooling, for example.

In addition or in alternative, the finely ground paste obtained in step c) may be subjected to a pH modulation step, preferably before the optional roasting step, in order to modify the physical properties, taste profile and subsequent development of flavors. For this purpose, bases (alkalization) or acids (e.g., treatment with acetic acid or citric acid) may be employed.

The above-described methods enable simple, rapid and inexpensive preparation of an edible fat-containing product and make ideal use of the naturally present, nutritionally beneficial components.

### Nut Paste and Related Products

In a second embodiment, the present invention relates to an edible fat-containing product obtainable by the method according to the first embodiment described above.

The edible fat-containing product exhibits favorably smooth texture and mouthfeel due to the fine grinding step described in step c) and the therein described particle sizes. In addition, due to the incorporation of nutshell material or drupe endocarp as filler, the edible fat-containing product has favorably high contents of antioxidants and bioactive substances preserving the flavor substances. Furthermore, since no water has been added to the mixture subjected to grinding and low fat contents may be achieved, the edible fat-containing product is resistant to rancidity and/or microbiological contamination, which leads to an extended shelf life.

In general, the edible fat-containing product obtained in step c) may be directly packaged (e.g. in a container) and/or used for consumption or confectionery processing, for example.

Alternatively, the edible fat-containing product may be further processed to modify the flavor, sweetness, texture and/or viscosity of the product to the desired recipe, e.g. by mixing the same with additives described above with respect to step b). In a preferred embodiment, the edible fat-containing product (e.g. nut paste) is processed in a refiner or a refiner/conche (e.g. a Macintyre all-in-one refiner/conche) in analogy to chocolate processing, to remove volatiles, acidity and moisture, to effect mixing with optional additives such as sugar, milk powder etc., and to improve the texture of the final product. If desired, larger particles may be introduced into the paste at this stage, including, but not limited to fruit pieces, nut particles (which may be roasted, oil-fried and/or sugar coated), coffee nibs, cocoa nibs, chocolate pieces, caramel pieces, or the like. However, in order to make full use of the benefits of the present invention, it is preferred that the final edible fat-containing product still contains at least 0.03 wt.-% of the surface-treated nutshell material or drupe endocarp based on the total weight of solids, more preferably at least 0.05 wt.-%, and especially preferably at least 0.5 wt.-%, such as 1 wt.-% or more or 5 wt.-% or more.

In addition, the edible fat-containing product may be optionally homogenized and/or ultrafinely ground to further reduce the particle size (e.g. to an average particle size of 25 μm or less or 15 μm or less) to create a smoother texture.

Exemplary confectioneries into which the edible fat-containing product of the present invention are incorporated are not specifically limited and may incorporate the edible fat-containing product as filling, topping or other ingredient in desserts, such as chocolates, cakes, pastries, cookies, confection, ice creams, sorbets, candy bars or the like.

### Use of Surface-Treated Nut Shell Material and Drupe Endocarb

In a third embodiment, the present invention relates to the use of drupe endocarb, surface-treated nut shells and/or surface-treated non-shelled nuts in ground form as filler material in the preparation of food, wherein the drupe endocarb, surface-treated nut shells and/or surface-treated have been ground without addition of water.

Specifically, this embodiment relates to the use of drupe endocarb, surface-treated nut shells and/or surface-treated non-shelled nuts which have been optionally pre-processed, surface-treated according to step a) and subjected to grinding without water addition according to step b) as described in conjunction with the first embodiment above.

The thus obtained material may be used in any food (both for human and animal consumption) to replace conventional filler materials added to provide dietary fiber and/or bulk, such as cellulose-based or soy-based fillers, for example. Accordingly, due to the high contents of biologically active components, the ground drupe endocarb and nutshell material serves as a nutritionally beneficial alternative to commonly used, non-nutritive food fillers. Moreover, drupe endocarb and nutshell materials previously discarded as undesired by-products may be exploited, which provides both economic and environmental advantages.

It will be appreciated that the present invention may employ any of the preferred features specified above with respect to the description of the first to third embodiments, and that the preferred features may be combined in any combination, except for combinations where at least some of the features are mutually exclusive.

Once given the above disclosure, many other features, modifications, and improvements will become apparent to the skilled artisan.

1-24. (canceled)

25. A method for preparing an edible fat-containing food product, comprising the steps of:
a) treating the surface of nutshells and/or non-shelled nuts to remove surface contaminants;
b) preparing a mixture comprising at least one of:
b1) surface-treated non-shelled nuts,
b2) fat-containing food and surface-treated nutshells,
b3) fat-containing food and surface-treated non-shelled nuts, or
b4) fat-containing food and drupe endocarp; and
c) grinding the mixture to an average particle size of 500 μm or less to provide an edible fat-containing food product;
wherein the mixture contains at least 0.05 wt.-% of surface-treated nutshell material or at least 0.05 wt.-% of drupe endocarp based on the total weight of solids; and
wherein the mixture does not contain added water.

26. The method for preparing an edible fat-containing food product according to claim 25, wherein shelled culinary nuts are used as the fat-containing food and the edible fat-containing food product is a nut paste.

27. The method for preparing an edible fat-containing food product according to claim 25, wherein in step b), the surface-treated nutshells and/or the surface-treated non-shelled nuts are added until the mixture has a total fat content of from 22 to 37 wt.-%; and
wherein step c) is at least initially performed with a roller mill.

28. The method for preparing an edible fat-containing food product according to claim 25, wherein the mixture prepared in step b) has a total fat content of less than 22 wt.-% or more than 37 wt.-%; and
wherein step c) is performed with a pin mill, a hammer mill, a screen mill, a colloid mill or combinations thereof.

29. The method for preparing an edible fat-containing food product according to claim 25, wherein the nutshells are selected from hazelnut shells, peanut shells, walnut shells, almond shells, pistachio shells, and combinations thereof; and/or
wherein the non-shelled nuts are selected from non-shelled hazelnuts, non-shelled peanuts, non-shelled walnuts, non-shelled almonds, non-shelled pistachios, and combinations thereof.

30. The method for preparing an edible fat-containing food product according to claim 25, wherein the shelled culinary nuts are selected from nuts, drupe seeds, nut-like gymnosperm seeds and nut-like angiosperm seeds.

31. The method for preparing an edible fat-containing food product according to claim 25, wherein the ground mixture obtained in step c, the surface-treated nuts, or the non-shelled nuts have been subjected to a roasting step before step c) at a temperature of more than 65° C. and less than 200° C.

32. The method for preparing an edible fat-containing food product according claim 25, wherein the mixture prepared in step b) comprises surface-treated non-shelled nuts or shelled culinary nuts and surface-treated nutshells in a (total) content of at least 1% by weight based on the total weight of solids.

33. The method for preparing an edible fat-containing food product according to claim 25, wherein step a) includes abrasive blasting of the surface of the nutshells and/or non-shelled nuts, the abrasive blasting being performed with nutshell abrasives.

34. The method for preparing an edible fat-containing food product according to claim 25, wherein step a) includes one or more of: chemical sterilization, washing in sterile water, surface sterilization or pasteurization by means of heat, surface sterilization or pasteurization by means of irradiation with ionizing rays, and ultrasound-based sterilization.

35. The method for preparing an edible fat-containing food product according to claim 25, wherein the mixture prepared in step b) comprises:
surface-treated non-shelled nuts or shelled culinary nuts and surface-treated nutshells in a (total) content of from 5 to 99% by weight;
sweetening agents, sweeteners, or combinations thereof, in a total content of from 0.5 to 60% by weight;
one or more edible oils in a total content of from 0.1 to 55% by weight; and
one or more additives selected from milk powder, flavoring agents, emulsifiers and combinations thereof, in a total content of from 0.1 to 50% by weight.

36. The method for preparing an edible fat-containing food product according to claim 25, further comprising the steps of:
a) separating drupe endocarp from drupe seed kernels;
b) preparing a mixture comprising fat-containing food and drupe endocarp; and
c) grinding the mixture to an average particle size of 500 μm or less to provide an edible fat-containing food product;
wherein the mixture contains at least 0.05 wt.-% of drupe endocarp based on the total weight of solids, and wherein the mixture does not contain added water.

37. The method for preparing an edible fat-containing food product according to claim 36, wherein shelled culinary nuts are used as the fat-containing food and the edible fat-containing food product is a nut paste.

38. The method for preparing an edible fat-containing food product according to claim 36, wherein in step b), drupe endocarp is added until the mixture has a total fat content of from 22 to 37 wt.-%; and
wherein step c) is at least initially performed with a roller mill.

39. The method for preparing an edible fat-containing food product according to claim 36, wherein the mixture prepared in step b) has a total fat content of less than 22 wt.-% or more than 37 wt.-%; and
wherein step c) is performed with a pin mill, a hammer mill, a screen mill, a colloid mill or combinations thereof.

40. The method for preparing an edible fat-containing food product according to claim 36, wherein drupe endocarp is obtained from at least one of apricots, olives, dates, pistachios, cherries, blackberries, peaches, coconuts, mangoes and/or combinations thereof.

41. The method for preparing an edible fat-containing food product according to claim 36, wherein drupe endocarp is separated from drupe seed kernels, and the separated drupe seed kernels are detoxified and reintroduced into the mixture in step b).

42. The method for preparing an edible fat-containing food product according to claim 36, wherein sweetening agents and/or sweeteners are added to the ground mixture after step c) and the mixture is subsequently subjected to a roasting step at a temperature of more than 65° C. and less than 200° C.

43. A method of using drupe endocarp, surface-treated nut shells and/or surface-treated non-shelled nuts in ground form as filler material in the preparation of food, wherein the drupe endocarp, surface-treated nut shells and/or surface-treated non-shelled nuts have been ground without addition of water.

44. The method according to claim 43, wherein drupe endocarp, surface-treated nut shells and/or surface-treated non-shelled nuts have been ground to an average particle size of 500 μm or less.
